(19) United States
(12) Patent Application Publication
(10) Pub. No.: US 2025/0297860 A1
(43) Pub. Date: Sep. 25, 2025

(54) Method for Two-Stage Monitoring of Inertial Sensors in a Vehicle with a Local Monitoring Unit and an External Remote Computer

(71) Applicant: Robert Bosch GmbH, Stuttgart (DE)

(72) Inventors: Jorge Juan Robles, Leonberg (DE); Ivo Kahle, Sachsenheim (DE)

(21) Appl. No.: 19/080,835

(22) Filed: Mar. 15, 2025

(30) Foreign Application Priority Data
Mar. 20, 2024 (DE) 10 2024 202 655.7

(51) Int. Cl. G01C 21/16; G07C 5/00

(52) U.S. Cl. CPC G01C 21/16; G07C 5/008

(57) ABSTRACT

A method for monitoring inertial sensors in a vehicle having a local monitoring unit and a remote computer is disclosed. The monitoring unit is arranged inside the vehicle and the remote computer is located outside the vehicle and spatially separate from the vehicle. The method includes (a) providing at least one inertial sensor signal, (b) providing metadata for the at least one inertial sensor signal, which includes at least one feature of the at least one inertial sensor signal, (c) storing the at least one inertial sensor signal together with the metadata provided for it, (d) sending at least one inertial sensor signal stored in step (c) together with the metadata provided for it to the local monitoring unit and to the remote computer based on this metadata, and (e) performing monitoring with the monitoring unit and the remote computer.

This application claims priority under 35 U.S.C. § 119 to application no. DE 10 2024 202 655.7, filed on Mar. 20, 2024 in Germany, the disclosure of which is incorporated herein by reference in its entirety.

### BACKGROUND

The present disclosure relates to a method for two-stage monitoring of inertial sensors in a vehicle with a local monitoring unit and an external remote computer. Additionally, a vehicle and a distributed system using the proposed method are described. The disclosure can particularly be used for autonomous or semi-autonomous driving.

Powerful inertial measurement units (IMU) with a plurality of inertial sensors are often used for autonomous driving with high safety and accuracy requirements and measure, for example, the physical movement of a vehicle in terms of acceleration and rotation rate.

Autonomous driving requires the use of highly accurate and reliable inertial sensor signals. Therefore, redundant inertial sensors are typically used to measure the same physical event to determine safety- and accuracy-related deviations by comparing the captured redundant inertial sensor signals. Furthermore, based on the determined deviations, the captured redundant inertial sensor signals can be set as valid or invalid, so that the redundant inertial sensor signals set as valid can be further combined or fused into a “best” final signal (fusion algorithm), and the redundant inertial sensor signals set as invalid can be avoided or minimized for subsequent calculations. It is also possible to select only a single “best” sensor signal among all available redundant sensor signals.

For redundant inertial sensors, a monitoring unit is typically arranged in the vehicle, which is able to determine safety- and accuracy-related deviations and provide information about the performance of the redundant inertial sensors. The monitoring unit can determine the inertial sensor signals most suitable for selection, combination or fusion based on a small amount of information when large deviations (e.g., large offset errors) are detected in a short time.

However, if the detected deviations are too small, a large amount of information is typically required to determine the most suitable inertial sensor signals. Even if a “best” inertial sensor can be well determined, it must be taken into account that the inertial sensor currently recognized as the one with the best performance might no longer be the best one over time depending on the situation/context.

Proceeding therefrom, the object of the present disclosure is to alleviate or at least partially solve the problems described in relation to the prior art. In particular, a method for two-stage monitoring of inertial sensors in a vehicle with a local monitoring unit and a remote computer is to be specified, which allows inertial sensors to be not only better monitored but also characterized and calibrated during their service life.

### SUMMARY

Contributing to this is a method for monitoring inertial sensors in a vehicle having a local monitoring unit and a remote computer, wherein the monitoring unit is arranged inside the vehicle and the remote computer is arranged outside the vehicle and spatially separated from the vehicle, comprising the following steps:
a) Providing at least one inertial sensor signal,
b) providing metadata for the at least one inertial sensor signal, which includes at least one feature of the at least one inertial sensor signal,
c) storing the at least one inertial sensor signal together with the metadata provided for it,
d) sending at least one inertial sensor signal stored in step c) together with the metadata provided for it to the local monitoring unit and to the remote computer based on this metadata, and
e) performing monitoring with the monitoring unit and the remote computer.

The method described is particularly suitable for autonomous driving. Autonomous driving refers in particular to the movement of vehicles that behave largely autonomously, at least with the aid of inertial sensors, e.g., for inertial navigation. The vehicles may be motor vehicles, for example a passenger car, a truck or another commercial vehicle, a robot or similar.

The described method allows two-stage monitoring of the inertial sensors installed in the vehicle. The inertial sensors can be monitored not only on-site by a monitoring unit also installed in the vehicle but can also be remotely monitored long-term by a remote computer arranged outside and spatially separated from the vehicle.

In contrast to known approaches that typically use only current inertial sensor signals to monitor inertial sensors, the monitoring unit proposed here can not only use current inertial sensor signals but also stored historical inertial sensor signals, thereby achieving improved on-site monitoring.

As the remote computer is not fixedly connected to a vehicle, it can, in principle, receive and use the stored historical inertial sensor signals not only from a particular vehicle but also from a plurality of different vehicles. This has the particular advantage that the remote computer can, on the one hand, assist the monitoring unit of a specific vehicle in monitoring the inertial sensors installed in that vehicle, and on the other hand, can also perform advanced tasks such as characterization and calibration of inertial sensors of the same type based on the stored inertial sensor signals provided by inertial sensors of the same type in different vehicles. The characterization and calibration of inertial sensors, in turn, assist the local monitoring unit in on-site monitoring. In this way, the local monitoring unit and the remote computer can functionally support each other to better monitor the inertial sensors.

Moreover, metadata is created for the inertial sensor signals to be stored that describe the characteristics of the inertial sensor signals, such as the priorities of the inertial sensor signals, on the basis of which efficient signal storage, signal communication, and signal usage are made possible.

According to step a), at least one inertial sensor signal is provided.

An inertial sensor signal can be provided by an inertial sensor installed in the vehicle. As a plurality of inertial sensors are installed in a vehicle, it is possible that a plurality of inertial sensor signals are provided by the respective inertial sensors. In particular, the inertial sensor signals may be redundant inertial sensor signals provided by the redundant inertial sensors.

Inertial sensors are, for example, accelerometers and rotation rate sensors that are typically installed in a vehicle for multi-dimensional measurements. It may be provided that, for each dimension, at least one inertial sensor of the same type, e.g., a rotation rate sensor is used to measure the physical quantity (e.g., the rotation rate) in that dimension. To increase measurement accuracy and avoid sensor failures, it may also be provided that a plurality of inertial sensors of the same type are used for each dimension to measure the same physical quantity in the same dimension. For example, three rotation rate sensors may be mounted on the same board to measure the same rotation rate in the same dimension. The same applies to accelerometers for multi-dimensional measurement of accelerations. Thus, a plurality of inertial sensors of the same type are installed in a vehicle.

Redundant inertial sensors herein are to be understood as inertial sensors that all have an identical design, an identical measured variable, and/or an identical measurement principle.

According to step b), metadata is provided for the at least one inertial sensor signal, comprising at least one feature of the at least one inertial sensor signal.

Generally, metadata is supplemental data to other data and describes the properties of the other data.

For a provided inertial sensor signal, metadata may be provided with at least one feature of this inertial sensor signal, wherein the at least one feature is, for example, the priority of this inertial sensor signal. It may be provided that metadata is created in step b) for each inertial sensor signal provided in step a). The use of metadata for each inertial sensor signal facilitates the evaluation and decision as to why and how an inertial sensor signal is to be further processed and/or used.

The metadata provided for an inertial sensor signal may be appended to the start of that inertial sensor signal in the form of a meta header and form a data block together with that inertial sensor signal. This has the advantage that the respective inertial sensor signals, based on their at least one feature included in the metadata, e.g., the priority, can be stored, transmitted, processed, and/or reused in blocks of data.

According to step c), the at least one inertial sensor signal is stored together with the metadata provided for said inertial sensor signal.

It may be provided that each inertial sensor signal provided in step a) is stored in a storage unit together with its metadata provided in step b).

Compared to the currently provided inertial sensor signals, the stored inertial sensor signals are historical inertial sensor signals that can later be selectively and opportunely utilized depending on the application needs to support improved monitoring of the inertial sensors.

Over time, the inertial sensor signals stored in the storage unit may be overwritten. This has the advantage that the storage space in the storage unit can be efficiently utilized. Overwriting can be based on metadata stored together with the corresponding inertial sensor signals. For example, inertial sensor signals with low priority values may be overwritten first when the priority values are included as features in the metadata of the respective inertial sensor signals.

According to step d), the at least one inertial sensor signal stored in step c) is sent together with the metadata provided for it to the local monitoring unit and to the remote computer based on this metadata.

It may be provided that inertial sensor signals together with their associated metadata can be selectively and opportunely sent from the storage unit to the monitoring unit and/or the remote computer, depending on the application needs. Sending may be based on metadata. For example, inertial sensor signals with high priority values may be sent first when the priority values are included as features in the metadata of the respective inertial sensor signals.

According to step e), the monitoring is performed with the monitoring unit and the remote computer.

The significant difference between the local monitoring unit and the remote computer is that the monitoring unit is in the vehicle and can be a signal processor, microcontroller, or similar, while the remote computer is outside the vehicle and spatially separated from it and can be a cloud (also referred to as a “computer cloud”).

The monitoring unit is used primarily for on-site monitoring. In doing so, the monitoring unit can use not only the current inertial sensor signals but also the current inertial sensor signals in conjunction with the stored historical inertial sensor signals, thereby achieving improved on-site monitoring. The same applies to the metadata.

The remote computer can, in principle, receive and use the stored historical inertial sensor signals not only from a particular vehicle but also from a plurality of different vehicles. This has the advantage that the remote computer can, on the one hand, assist the monitoring unit of a specific vehicle in monitoring the inertial sensors installed in that vehicle, and on the other hand, can also perform advanced tasks such as characterization and calibration of inertial sensors of the same type based on the stored inertial sensor signals provided by inertial sensors of the same type in different vehicles. The characterization and calibration of inertial sensors, in turn, assist the local monitoring unit in on-site monitoring. In this way, the local monitoring unit and the remote computer can functionally support each other to better monitor the inertial sensors.

In particular, the remote computer can perform the following (advanced) tasks:
support the local monitoring unit for on-site monitoring,
characterize the inertial sensors,
calibrate the inertial sensors,
reconstruct accidents,
create test environments for new monitoring algorithms to monitor inertial sensors, and
estimate road conditions.

It may be provided that the remote computer may receive and use inertial sensor signals from various vehicles. This has the advantage that the monitoring unit of a single vehicle and its fusion algorithm can be improved. As mentioned earlier, because the safety and accuracy-related deviations determined based on the redundant inertial sensor signals are too low, a large amount of information is usually required to determine the “best” inertial sensors. With the remote computer, it is possible to use a large amount of inertial sensor signals over time, not only from the local redundant inertial sensors in a particular vehicle but also from inertial sensors of the same type in several other vehicles. For example, using an artificial intelligence (AI) algorithm to detect anomalies can evaluate the performance of the inertial sensors (e.g., as best or worst). Moreover, this evaluation can be transmitted to the vehicle, which can improve the monitoring unit of a single vehicle and its fusion algorithm.

It may be provided that the remote computer characterizes the inertial sensors using inertial sensor signals from different vehicles. From the large amount of inertial sensor signals from different vehicles, statistical data can be generated to characterize the behavior and tolerance of the inertial sensors. These statistical data can be used, e.g., for future risk analyses and predictions.

It may be provided that the remote computer calibrates the inertial sensors by using inertial sensor signals from inertial sensors of the same type from different vehicles in order to learn how their tolerances (e.g., offset) change under different environmental conditions (e.g., temperature, humidity, age). This information can be used to create calibration curves (e.g., offset vs. temperature) for the inertial sensors of this specific sensor type to improve their performance.

It may be provided that the remote computer reconstructs accidents by providing the inertial sensor signals while a vehicle is traveling on relevant road sections, such as dangerous intersections or sharp bends, and later sending them to the remote computer and storing them in the remote computer, so that an accident that has occurred on these relevant road sections can be reconstructed using these stored inertial sensor signals and the course of the accident can be better understood.

It may be provided that the remote computer is used as a test platform for new monitoring algorithms by using inertial sensor signals from different vehicles to train an artificial intelligence (AI) algorithm or test new inertial sensor-based functions.

It may be provided that the remote computer, with the aid of an AI algorithm, estimates the road condition based on inertial sensor signals captured during travel of different vehicles on the same route and sent to the remote computer and stored in the remote computer. In this way, for example, possible structural changes in the road, such as cracks in the road surface or rut depth, can be detected.

It is preferred if a priority value for the at least one inertial sensor signal is defined before step b).

As not all current inertial sensor signals are relevant for further use, a priority value can be defined for each current inertial sensor signal based on which the irrelevant inertial sensor signals can be filtered out to enable efficient signal storage, signal communication, and signal use.

It is preferable if the priority value is defined taking into account at least one of the following factors:
trigger control unit information,
road and position information,
environmental and context information,
monitoring unit evaluation.

The priority values of the respective inertial sensor signals can be defined by a priority management unit.

It may be provided that the priority values of the respective inertial sensor signals can be defined taking into account the monitoring unit evaluation. For example, if the monitoring unit determines that all inertial sensors are within the performance specification, but a particular inertial sensor exhibits unexpected behavior or the inertial sensor signals provided by the inertial sensors show strong fluctuations, higher priority values can be assigned to those inertial sensor signals. This means that these inertial sensor signals may be relevant, interesting, or useful for further use. It is possible to use the internal qualification mechanisms of the monitoring algorithms (e.g., counters for qualifying occurring problems) in order to define the priority values of the respective inertial sensor signals.

It may also be provided that the priority values are defined taking into account at least one trigger controller independent of the inertial sensors. The trigger controller can be an AIRBAG controller arranged in the same vehicle as the inertial sensors. If, for example, the AIRBAG controller detects that some impact detection algorithms are active, the inertial sensor signals provided by the inertial sensors at that time may be relevant in order to understand why the impact detection algorithm triggered the airbag. Higher priority values can also be assigned to these inertial sensor signals.

It may also be provided that the priority values are defined taking into account environmental and context information. If, for example, the temperature or humidity is outside the specified range, the priority values for the inertial sensor signals provided at that time and thereafter may be increased.

It may further be provided that the priority values are defined taking into account roadway and vehicle position information. The inertial sensor signals provided by the inertial sensors may exhibit strong fluctuations and/or disturbances on certain roadways or at certain positions, e.g. on tight curves. In order to distinguish fluctuation and/or malfunctions caused by roadways from variations and/or malfunctions caused by non-functioning inertial sensors, critical roadways and positions may be marked in advance on a navigation map. If, for example, the navigation system navigating a vehicle with the navigation map indicates that the vehicle is approaching a curve marked on the navigation map in the next few seconds, a particular priority value may be assigned to each of the inertial sensor signals provided by the inertial sensors during travel on that curve.

It is preferred if, in step b), the metadata is provided with the priority value. In this way, the stored inertial sensor signals may be sent to the remote computer according to their priority values, wherein the inertial sensor signals having higher priority values are more relevant and may therefore be sent first.

It is preferred if, in step b), the metadata is additionally provided with at least one of the following features: roadway and position characteristic, time information, sampling frequency, environmental and context information, level of data compression, data block size, system relevance characteristic value. This has the advantage that the stored inertial sensor signals can be further used depending on the specific conditions and circumstances. The roadway and position characteristic value may refer to the roadways and positions marked in the navigation map. The system relevance characteristic value may refer to another system, such as the AIRBAG controller.

It is preferred if a temporary buffer and a priority-oriented memory are used in step c).

A current inertial sensor signal with its metadata may first be stored in the temporary buffer for a few seconds until the priority management unit has defined a priority value for that inertial sensor signal. If the priority value is zero, this means that this inertial sensor signal is not relevant and thus can be overwritten, for example, according to a FIFO (first in, first out) strategy.

If the priority value is high, this means that this inertial sensor signal is relevant. To this end, the metadata for this inertial sensor signal is updated so that this inertial sensor signal deemed relevant can be copied to the priority-oriented memory together with the updated metadata. Subsequently, the contents of the temporary buffer can be overwritten. For example, the priority-oriented memory is a non-volatile memory.

It is possible that the data to be copied into the priority-oriented memory (i.e., the inertial sensor signal deemed relevant and its metadata) can be compressed in advance as needed. The data copied into the priority-oriented memory can be used by both the monitoring unit and the remote computer.

It is also possible to use a plurality of temporary buffers to buffer the inertial sensor signals over an extended period of time. If, for example, a temporary buffer is full, the subsequent inertial sensor signals can be stored in another temporary buffer.

It is preferred if, in step d), the at least one inertial sensor signal together with the metadata provided for it is sent to the remote computer based on the priority value included in said metadata.

It is preferred if, in step d), the at least one inertial sensor signal together with the metadata provided for it is sent to the remote computer directly via an internet connection or indirectly via a medium.

It may be provided that the stored inertial sensor signals together with their corresponding metadata are sent via an internet connection directly to the remote computer when an internet connection is available, wherein the inertial sensor signals with high priority values can be sent first.

It may also be provided that the stored inertial sensor signals together with the corresponding metadata are sent to the remote computer indirectly via a medium.

The medium may be a cell phone of the user. In this case, the inertial sensor signals together with the associated metadata are first transmitted to the cell phone, which can then be forwarded from the cell phone to the remote computer. For example, the inertial sensor signals having lower priority values may be transmitted to the cell phone of the user. If the cell phone has an internet connection and enough bandwidth (e.g., Wi-Fi at home), it will be routed to the remote computer.

The medium may also be a smart traffic light, a traffic control system that combines a conventional traffic light with a number of sensors and artificial intelligence. If a stable, high speed, short range data link can be established between the vehicle and the intelligent traffic light, the lower priority inertial sensor signals can be transmitted to the intelligent traffic light, which then forwards them to the remote computer.

The medium may also be a charger that can be used to transfer data via PLC (Power Line Communication). If the vehicle is an electric vehicle, the vehicle may communicate with the charger during the charging process. In this way, the inertial sensor signals having lower priority values may be transmitted to the charger, which then passes them to the remote computer.

In all of these cases, it is possible that the datasets stored in the priority-oriented memory may not be deleted until the remote computer confirms that they have been received in full.

Furthermore, a vehicle having a plurality of inertial sensors and a monitoring unit for monitoring the inertial sensors is proposed, comprising:
a priority management unit configured to determine a priority value for an inertial sensor signal,
a metadata mapping unit configured to provide metadata for an inertial sensor signal,
a data storage unit configured to store an inertial sensor signal with the metadata provided for it, and
a data transmission unit that can be connected to a remote computer in a data-conducting manner, wherein the remote computer is arranged spatially separated from and outside the vehicle.

It is preferred if the data storage unit includes a temporary buffer and a priority-oriented memory.

It is also preferred that the data storage unit includes a plurality of temporary buffers.

It is further preferred that the data transmission unit is configured to send one inertial sensor signal together with the metadata provided to the remote computer directly via an internet connection or indirectly via a medium.

Additionally, a distributed system with a remote computer and at least one of the previously described vehicles is proposed, wherein the at least one vehicle can be connected to the remote computer in a data-conducting manner.

It is preferred if the remote computer is configured to perform at least one of the following tasks:
supporting the monitoring unit of the at least one vehicle,
characterizing the inertial sensors of the at least one vehicle,
calibrating the inertial sensors of the at least one vehicle,
reconstructing accidents,
creating test environments for new monitoring algorithms,
assessing road conditions.

The concepts presented here share a common two-stage monitoring approach. The inertial sensors installed in a vehicle can be monitored not only on-site by a monitoring unit also installed in the vehicle but can also be remotely monitored long-term by a remote computer arranged outside and spatially separated from the vehicle. In this way, the local monitoring unit and the remote computer can functionally support each other to better monitor the inertial sensors. Moreover, metadata is created for the inertial sensor signals to be stored that describe the characteristics of the inertial sensor signals, such as the priorities of the inertial sensor signals, on the basis of which efficient signal storage, signal communication, and signal usage are made possible.

### BRIEF DESCRIPTION OF THE DRAWINGS

The solution presented here and its technical environment are explained in more detail below, using the figures. It should be noted that the disclosure is not intended to be limited by the exemplary embodiments shown. In particular, unless explicitly stated otherwise, it is also possible to extract partial aspects of the facts explained in the figures and to combine them with other components and/or insights from other figures and/or the present description. Shown schematically are:

FIG. 1 a block diagram of a described method, and

FIG. 2 data transfer between a vehicle and a remote computer.

### DETAILED DESCRIPTION

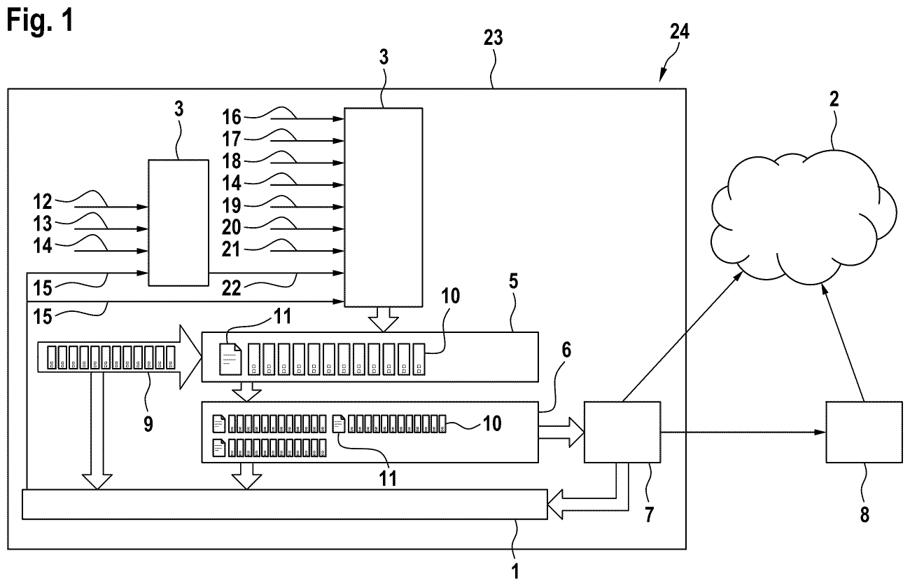

FIG. 1 schematically and exemplary shows a block diagram of a described method. With the method, the inertial sensors arranged in a vehicle 23 can be monitored not only on-site by a monitoring unit 1 also arranged in the vehicle 23 but can also be remotely monitored long-term by a remote computer 2 arranged outside and spatially separated from the vehicle 23.

For this purpose, a priority value 22 is in particular defined for each inertial sensor signal 9 by a priority management unit 3. The priority value 22 may be defined based on the monitoring unit evaluation 15. The priority value 22 can additionally be defined based on external inputs, such as trigger controller information 12, roadway and vehicle position information 13, and/or environmental and context information 14.

Furthermore, metadata 11 is created by a metadata mapping unit 4 for each inertial sensor signal 9 to be stored.

The metadata 11 of an inertial sensor signal 9 to be stored may comprise the previously defined priority value 22 of that inertial sensor signal 9. Furthermore, metadata 11 may additionally include a roadway and location characteristic value 16, time information 17, a sampling frequency 18, environmental and context information 14, a level of data compression 19, a data block size 20, and/or a system relevance characteristic value 21. Thus, the priority value 22, roadway and position characteristic value 16, time information 17, sampling frequency 18, environmental and context information 14, level of data compression 19, data block size 20, and system relevance characteristic value 21 together form the features of this inertial sensor signal 9 which may describe the priority and context of this inertial sensor signal 9.

An inertial sensor signal 9 to be stored can be stored in a data storage unit 5, 6 together with the metadata 11 previously created for this inertial sensor signal 9.

The data storage unit 5, 6 can comprise a temporary buffer 5 and a priority-oriented memory 6. A current inertial sensor signal 9 with its metadata may be first stored in the temporary buffer 5 for a few seconds until the priority management unit 3 has defined a priority value 22 for that inertial sensor signal 9. If the priority value 22 is zero, this means that this inertial sensor signal 9 is not relevant and thus can be overwritten, for example, according to a FIFO (first in, first out) strategy.

If the priority value 22 is high, this means that this inertial sensor signal 9 is relevant. To this end, the metadata 11 for this inertial sensor signal 9 is updated so that this inertial sensor signal 9 deemed relevant can be copied to the priority-oriented memory 6 together with the updated metadata 11. Subsequently, the contents of the temporary buffer 5 can be overwritten. For example, the priority-oriented memory 6 is a non-volatile memory.

Data from priority-oriented memory 6 can be sent to remote computer 2 by a data transfer unit 7. Likewise, data may be received by the data transfer unit 7 from the remote computer 2. It is possible to send an inertial sensor signal 10 together with the metadata 11 provided for it to the remote computer 2 based on the priority value 22 included in that metadata 11. It is also possible to send an inertial sensor signal 10 together with the metadata 11 provided for it to the remote computer 2 directly via an internet connection or indirectly via a medium 8.

In FIG. 1, it can further be seen that the vehicle 23 and the remote computer 2 together form a distributed system 24, in which the remote computer 2 is arranged outside the vehicle 23 and spatially separated from the vehicle 23 and is connectable in a data-conductive manner to the vehicle 23.

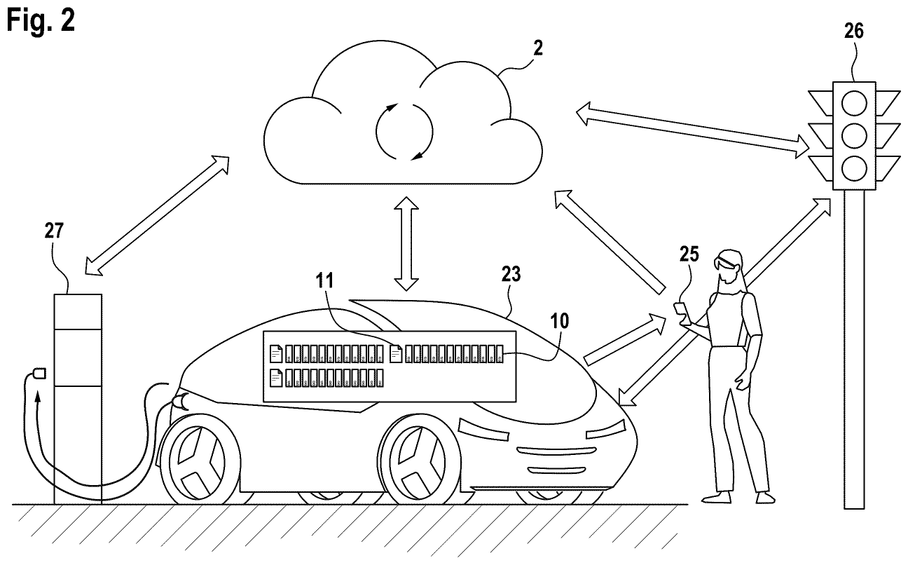

FIG. 2 schematically illustrates, by way of example, the data transfer between a vehicle 23 and a remote computer 2.

In FIG. 2, it can be seen that the stored inertial sensor signals 10 together with their corresponding metadata 11 can be sent directly to the remote computer 2 when an internet connection is available, wherein the inertial sensor signals with high priority values can be sent first.

In FIG. 2, it can also be seen that the stored inertial sensor signals 10 together with the corresponding metadata 11 can be sent to the remote computer 2 indirectly via a user's mobile phone 25, a smart traffic light 26, or a charger 27. The indirect transmission is particularly advantageous for inertial sensor signals with low priority values.

In the case of the mobile phone 25, the inertial sensor signals 10 together with the associated metadata 11, may first be transmitted to the mobile phone 25, which may then be forwarded from the mobile phone 25 to the remote computer 2.

In the case of the smart traffic light 26, the inertial sensor signals 10 together with the associated metadata 11 may be transmitted to the smart traffic light 26, which then forwards them to the remote computer 2 when a stable, high-speed, short-range data link can be established between the vehicle 23 and the smart traffic light 26.

In the case of charger 27, the inertial sensor signals together with the associated metadata 11 may be transmitted to charger 23, which then forwards them to remote computer 2 if charger 27 has PLC (Power Line Communication) and vehicle 23 can communicate with the charger 27 during the charging process.

In all these cases, it is possible that the stored inertial sensor signals 10 and their associated metadata 11 will not be deleted until the remote computer 2 confirms that they have been received in full. However, it is also possible that only the stored inertial sensor signals 10 with high priority values for deletion require confirmation.

What is claimed is:

1. A method for monitoring inertial sensors in a vehicle having a local monitoring unit and an external remote computer, wherein the monitoring unit is arranged inside the vehicle and the remote computer is arranged outside the vehicle and spatially separated from the vehicle, the method comprising:
(a) providing at least one inertial sensor signal;
(b) providing metadata for the at least one inertial sensor signal, which includes at least one feature of the at least one inertial sensor signal;
(c) storing the at least one inertial sensor signal together with the metadata provided for it;
(d) sending at least one inertial sensor signal stored in step (c) together with the metadata provided for it to the local monitoring unit and to the remote computer based on this metadata; and
(e) performing monitoring with the monitoring unit and the remote computer.

2. The method according to claim 1, wherein prior to step (b), a priority value for the at least one inertial sensor signal is defined.

3. The method according to claim 2, wherein the priority value is determined taking into account at least one of the following factors:
trigger controller information,
roadway and position information,
environmental and context information, and
monitoring unit evaluation.

4. The method according to claim 2, wherein in step (b), the metadata is provided with the priority value.

5. The method according to claim 4, wherein in step (b), the metadata comprises at least one of the following features:
roadway and position characteristic value,
time information,
sampling frequency,
environmental and context information,
level of data compression,
data block size, and
system relevance characteristic value.

6. The method according to claim 1, wherein in step (c) a temporary buffer and a priority-oriented memory is used.

7. The method according to claim 2, wherein in step (d), the at least one inertial sensor signal together with the metadata provided for it is sent to the remote computer based on the priority value included in the metadata.

8. The method according to claim 1, wherein in step (d), the at least one inertial sensor signal together with the metadata provided for said inertial sensor signal is sent directly to the remote computer via an internet connection or indirectly via a medium.

9. A vehicle having a plurality of inertial sensors and a monitoring unit for monitoring the inertial sensors, comprising:
a priority management unit configured to define a priority value for an inertial sensor signal;
a metadata mapping unit configured to provide metadata for an inertial sensor signal;
a data storage unit configured to store an inertial sensor signal with the metadata provided for it, and
a data transmission unit connectable in a data-conducting manner to a remote computer, wherein the remote computer is arranged spatially separated from the vehicle and outside the vehicle.

10. The vehicle according to claim 9, wherein the data storage unit comprises a temporary buffer and a priority-oriented memory.

11. The vehicle according to claim 9, wherein the data storage unit comprises a plurality of temporary buffers.

12. The vehicle according to claim 9, wherein the data transmission unit is configured to send an inertial sensor signal together with the metadata provided for it to the remote computer directly via an internet connection or indirectly via a medium.

13. A distributed system with a remote computer and at least one vehicle according to claim 9, wherein the at least one vehicle is connectable in a data-conductive manner to the remote computer.

14. The distributed system according to claim 13, wherein the remote computer is configured to perform at least one of the following tasks:
supporting the monitoring unit of the at least one vehicle,
characterizing the inertial sensors of the at least one vehicle,
calibrating the inertial sensors of the at least one vehicle,
reconstructing accidents,
creating test environments for new monitoring algorithms, and
assessing road conditions.
